(19) United States
(12) Patent Application Publication
(10) Pub. No.: US 2009/0119186 A1
(43) Pub. Date: May 7, 2009

(54) Apparatus and Method for Ordering

(75) Inventor: Cosmin-Gabriel Ene, Munchen (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Cosmin-Gabriel ENE, Munchen (DE)

(21) Appl. No.: 12/296,163

(22) PCT Filed: Mar. 30, 2007
(86) PCT No.: PCT/EP07/02878

§ 371 Date: Oct. 6, 2008

(30) Foreign Application Priority Data
Apr. 5, 2006 (DE) 10 2006 015 974.8
Apr. 28, 2006 (DE) 10 2006 019 842.5

(51) Int. Cl. G06Q 30/00; G06Q 10/00

(52) U.S. Cl. 705/26; 705/1

(57) ABSTRACT

The present invention relates to an apparatus and a method for ordering an article from a plurality of articles. The apparatus or the method merely has a manageable set of identifiers. These identifiers are added to a given audio/video signal which advertises a particular article and is broadcast. If a person receiving the audio/video signal wishes to purchase the relevant article, this article can be identified by the identifier. Preferably, this identifier is a colored marker. Since the cardinality of the set of identifiers is kept relatively manageable, a plurality of articles is provided with the same identifier, that is to say the same color marker. The apparatus or the method is able to distinguish between articles with the same identifier by comparing the time at which the article was advertised with the time at which the order was received.

### CROSS-REFERENCE TO RELATED APPLICATIONS

This application is a Section 371 of International Application No. PCT/EP2007/002878, filed Mar. 30, 2007, which was published in the German language on Oct. 11, 2007, under International Publication No. WO 2007/112973 A1, and the disclosure of which is incorporated herein by reference.

### BACKGROUND OF THE INVENTION

The present invention relates to an apparatus and a method for ordering at least one article from a plurality of articles.

The sale of goods through the television, wherein products are presented to the final consumer which he can then order directly over the telephone, is known. This method of sales has enjoyed high popularity throughout the world, including Germany, for some time.

Usually in what is known as teleshopping, one or more products are advertised in a brief film. At the end of the short film, a telephone number is generally shown through which the product that is being advertised can be ordered. Frequently a plurality of products are offered in a sequence and each may be ordered from a different telephone number, so that the purchaser prepared to buy needs to note or remember a different number for each product.

Alternatively, it is also usual for a call centre with a single telephone number to be set up for a plurality of products wherein the purchaser must provide an article number to ensure that the sales transaction is completed promptly. Whichever of the two variants is selected by the company offering the goods for sale, the end customer or final consumer must always remember or note a column of numbers or combination of letters of some kind. This is a particular problem if a plurality of products is advertised in a rapid sequence of consecutive films. Errors occur which result in either the final customer being frustrated and refraining from purchasing a product, the wrong product being ordered, or the call centre taking unnecessary time.

The companies that offer such services are frequently concerned to handle the ordering process as efficiently as possible. This is why there have been numerous approaches using automated systems to handle the sale with the purchaser. In the simplest case, this means that a registered user calls up this automated system, is greeted by a voice announcement and can identify himself to the system using a personal identification number. Once this authentication is complete, he can order a specific article by entering the article number. If the aforementioned problems arise either in the entry of the number through the telephone keypad or if incorrect number sequences are entered, the automated ordering process is abandoned. The order must either be taken manually, i.e. by a human operator, or subsequently corrected, to the extent that this is possible. The staff must be employed as efficiently as possible so that such, frequently expensive, automated ordering systems are economically viable. Reworking erroneous orders makes this impossible and gives rise to considerable staff costs.

Many consumers are, furthermore, not interested in personal interaction with a sales person. They are looking for a service that can accept the order for an article at any time, easily and reliably. This is particularly the case in the ordering of individual pieces of music.

As the individual articles here have a relatively low value, the purchaser does not necessarily need a personal sales and advisory discussion. He only wants to give his order quickly and without complication and to receive the product, e.g. the piece of music. as quickly as possible.

Proceeding from this prior art, the problem to be solved by the present invention is to provide an apparatus and a method for ordering at least one article which ensures an efficient, essentially automated order, whereby the risk of an erroneous order is minimized.

This task is solved according to the invention by an apparatus in accordance with claim 1 and by a method in accordance with claim 12.

More particularly the problem is solved by an apparatus for ordering at least one article from a plurality of articles wherein the apparatus comprises a signal server for providing a plurality of audio/video signals, an article database for saving relations between the plurality of articles and the plurality of audio/video signals, an identifying device designed such that it assigns an identifier from a defined set of identifiers to each audio/video signal and saves this assignment in an identification database, a communications device designed such that it publishes the audio/video signal together with the identifier assigned and stores the time of publication in a program database and a communications device that is designed such that it receives an identifier input from a receiver of the audio/video signal, more particularly from a television viewer and determines at least one article to be ordered using the identifier input and the input time by means of data from the article database, the identification database and the program database.

### BRIEF SUMMARY OF THE INVENTION

The central idea behind the invention is thus to provide audio/video signals, advertising at least one article, with a relatively manageable set of identifiers and to publish the audio/video signals marked with the identifiers, i.e. to make it available for reception, in particular for reception on a television. During or before publication, both the assignment of an identifier to an audio/video signal or directly to an article is saved, as is the time of publication. It is immaterial here whether the information (identifier, time of publication) relating to an article is stored in one or several databases. The recipient of the published audio/video signal observes the identifier and can order the article by means of an identifier input, an input corresponding with the identifier. As the set of identifiers is relatively manageable, the identifiers can be selected such as to differ strongly from one another and to be easily noted. An erroneous interaction with a communications device provided to take the order is thereby avoided. If a plurality of articles is identified with such a small cardinality of identifiers, different articles and different audio/video signals can be identified with the same identifier. The invention solves this problem in that the time of ordering, that is the time that the identifier input is entered, and the time of publication are recorded. If the order is made contemporaneously, therefore, the correct article can always be determined, even if the identifier is repeated. Alternatively, a plurality of articles can also be put forward for ordering, that is a plurality of articles is proposed for ordering, wherein a weighting or organization of the sequence of articles can be undertaken in accordance with the time difference between the publication period and the input time.

Preferably the cardinality of the set of identifiers is less than or equal to ten. As already described, the individual identifiers can, in this way, be designed to be very different. The recipient, that is to say the customer, possibly already knows this predefined set of identifiers and thus has no problems in noting these. If the cardinality is ≦10, it is especially easy to enter the identifier through the telephone. Each identifier corresponds with a key on the telephone.

Although it is conceivable that the identifier is an alphanumeric value that is shown or mixed into the audio/video signal or the audio/video signals it would make a more effective impression if the identifier were to comprise signals that appear in the representation of the audio/video signal published in the form of color markings that the recipient could observe, more particularly in a traffic signal-like arrangement. In the representation of the audio/video signal, thus, a colored symbol will appear in the top right-hand corner, for instance. In the simplest case, this colored symbol could be a solid circle of a clearly distinguishable color. Preferably the cardinality of the set of identifiers is equal to three. The color markings thus essentially comprise the colors of red, amber and green. These color markings will be perceptible to the recipient, displayed on the screen of his television, for instance. It can be advantageous to display the color markings at different positions to make them even more easily distinguishable. For instance, the colors red, amber and green could be arranged one beneath the other, as on a traffic light. It is also conceivable that an actual image of a traffic light could also be shown around these color markings to further reinforce the association of the identifier.

Identifier input preferably comprises the input of a text, in particular the input of a color name. It is, thus, conceivable that the identifier input comprises the input of a word that the recipient associates with the identifier observed. It is especially advantageous if the identifier is not a numerical value, but a geometric figure, or symbol or color marking. The recipient can then communicate the concept associated with these identifiers to the communications equipment either by means of a computer keyboard over the Internet, by means of a telephone keypad, for instance a mobile phone, or as voice input.

The communications equipment preferably comprises an SMS receiver unit, which receives the identifier input in the form of an SMS text. The person receiving the video/audio signal, which has been assigned the identifier, thus writes an SMS text which contains, for instance, a color name such as red, amber or green, or a symbol name such as star, circle or square in text form, and sends this to the communications equipment. The communications equipment then analyses the identifier input. Automation may be implemented by the automatic comparison of the identifier input with a plurality of terms stored in an a database, each assigned to an identifier. The communications device is designed in such a way that it compares the identifier input with the aforementioned stored terms and determines an article accordingly. Identifier inputs can be processed in any language by means of a specific selection of terms.

The communications equipment preferably comprises telecommunications equipment for receiving the identifier input. In this case, for instance, the telephone number from which the identifier input was sent to the communications equipment can be determined and assigned to a specific user by means of a database of users. Preferably the communications equipment comprises a database of users for this purpose. This database of users can contain registration data for possible recipients of the audio/video signal marked with the identifier.

Preferably the plurality of articles comprises a plurality of audio signals or audio/video signals or of data media with at least one audio signal or audio/video signal. In the simplest case, therefore, precisely that audio/video signal can be ordered that has already been published by the publication apparatus in a form marked with an identifier. Alternatively, just the audio signal contained in the published audio/video signal can be identified as the article and hence ordered. It is also conceivable in this context that an audio/video signal or a pure audio signal on a data medium is ordered as an article.

The publication equipment preferably comprises a transmitter unit for a television program.

Preferably the plurality of audio/video signals comprises music videos. The audio/video signals marked with an identifier are thus music videos. A corresponding audio or audio/video file is then determined as the article by the apparatus.

The problem is also solved by a method for ordering at least one article from a plurality of articles, wherein the method comprises the steps:
marking an audio/video signal assigned to the article with an identifier from a defined set of identifiers;
publication of the marked audio/video signal in a publication period;
reception of an identifier input at a reception time;
determination of a set of articles, the assigned audio/video signals for which have been identified with an identifier that corresponds to the identifier input; and
selection of at least that article from the set of articles for which the interval between the reception time and a start time of the publication period of the assigned audio/video signal is the shortest.

The central idea of the method consists, similarly to that of the apparatus, in that an identifier is selected from a manageable number of identifiers and that this is mixed or combined with the audio/video signal in such a way that the identifier is perceivable by the recipient. The article marked with the identifier can be identified by an identifier input corresponding with the identifier of the audio/video signal of the article concerned. Since there is only a defined set of identifiers, repeat assignments can occur. In the course of the method, however, at least that article, the marked audio/video signal for which corresponds with the identifier input and the publication period, or the start point of the publication period, is closest in time to the time at which the identifier input was received.

Preferably the method includes the step of installing an application, particularly on a mobile phone, for sending the identifier input, wherein the application offers a selection from the defined set of identifiers. The installed application thus assists the user in generating an identifier input corresponding with the audio/video signal marked with the identifier. The user, therefore, need only remember what identifier he observed when receiving the audio/video signal.

Identifier input preferably comprises the input of a text, in particular the input of an SMS text. If the application described above is installed on the mobile phone, the user is preferably able to generate the identifier input from the application with the assistance of a selection menu. The application then generates a text message or SMS message that is sent to the communications equipment. There is no need for complex interaction with a system, for example using the alphanumeric keyboard on the telephone.

The method preferably additionally comprises the step of sending an offer, more particularly after the step of the selection of the article, which comprises a description and/or a price for the at least one article. Hence, as soon as an article has been selected for ordering, the user receives an offer containing a more detailed description and/or a price for the article. He will only have to agree to this offer to make the purchase. Inadvertently incorrect orders are prevented by the additional information that the user receives when the offer is sent.

Preferably the cardinality of the set of identifiers is less than or equal to ten. This has the advantages already described for the apparatus that the identifiers are easy to manage and make an impact.

Preferably the marking of an audio/video signal comprises mixing in a video signal with a color marking. Color markings have a particularly high recognition value for the recipient. This method of identifying items is non-culturally specific, simple and independent of education.

The method preferably comprises the step of registering a user, wherein the reception of the identifier input embraces the identification of a registered user. Therefore, if the user had registered himself in advance, there is no need for the complex input of name and address data. The article can possible be sent directly to the user without further interaction. During registration, the user can be asked for the data for the payment of possible orders or for the use of the service, in addition to his name and address data.

Further advantageous embodiments of the invention are described by the dependent claims.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a television set;

FIG. 2 is a process for marking an audio/video signal;

FIG. 3 is an apparatus for ordering an article with associated components; and

FIG. 4 is various options for interaction with communications equipment.

The same reference numbers will be used for identical and identically acting parts in the description below.

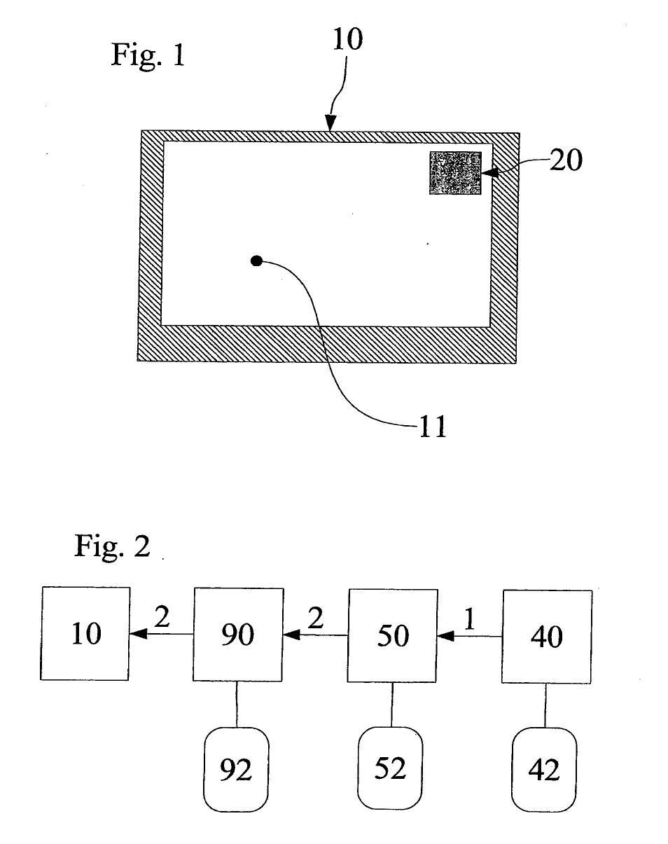

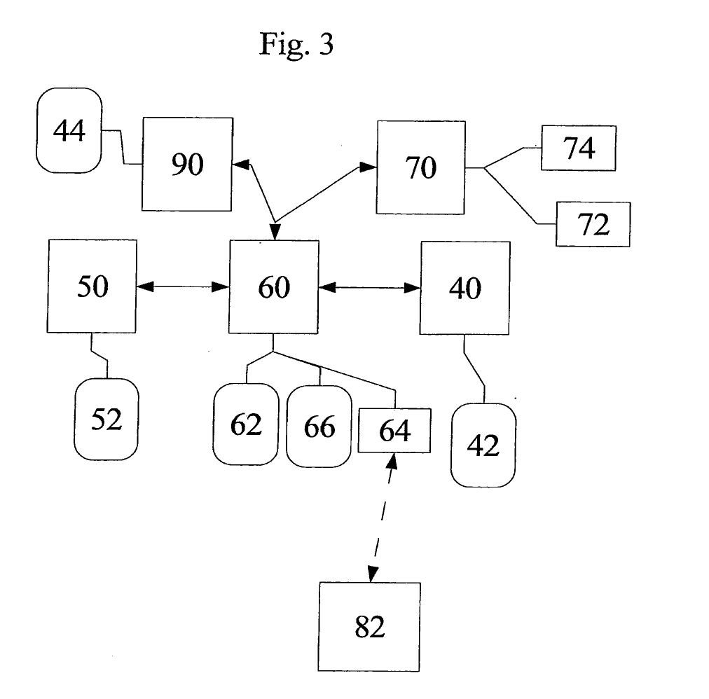

FIG. 1 shows the process according to the invention for marking an audio/video signal 1 with an identifier. This audio/video signal 1 is generated by a signal server 40. This signal server 40 comprise an article database 42 in which the relations between a plurality of articles and a plurality of audio/video signals 1 are stored. The signal server 40 sends one of the audio/video signals 1 from the plurality of audio/video signals 1 to identifying equipment 50. In the concrete embodiment example, the article database 42 contains a table with BLOB (BLOB: Binary Large Objects) fields in which an audio/video signal 1 is stored in the form of a digital data stream.

Alternatively, the signal server 40 can also send a plurality of audio/video signals 1 to identifying equipment 50. The identifying equipment 50 marks the unmarked audio/video signal 1 or the plurality of unmarked audio/video signals 1 with an identifier. This is done by mixing with the unmarked audio/video signal 1 a video signal that appears in the reproduction of audio/video signal 1 as a visible color marking 20 (cf. FIG. 1). The identifier is applied by means of an analogue or digital mixer that mixes the unmarked audio/video signal 1 with an identifier signal.

The outcome is an audio/video signal 2 marked with an identifier. The identifier equipment 50 comprises an identification database 52 that stores which audio/video signal 1 has been provided with which identifier. Alternatively, an article from the article database 42 can be assigned to an identifier. Various digital identifiers or identifying algorithms are stored or implemented on the identifying equipment 50.

The signal 2 marked with an identifier is passed to publication equipment 90. This sends the audio/video signal 2 marked with an identifier to a receiver, here a television receiver 10. The audio/video signal 2 marked with an identifier is published in this way. The period of the publication is stored in a program database 92 which is part of the publication equipment 90. It is frequently sufficient for the starting time of publication only to be stored instead of the publication period. On the one hand, the length of the audio/video signal 2 marked with the identifier is generally known and on the other hand, the starting time of publication is sufficient to establish when which audio/video signal 2 was published.

The program database 92 establishes a relationship between the identifier used and the audio/video signal 1, 2 or the corresponding article from the article database 42. It is only important in the implementation of the storage mechanisms and in the design of the individual databases 92, 52, 42 that a relationship can be established between the article, the associated audio/video signal, identifier and publication period or starting time of publication.

When a television receiver 10 (see also FIG. 1) receives the audio/video signal 2 marked with the identifier, the majority of the television image 11 is determined by the audio/video signal 1 that is not marked with the identifier. The identifier makes up just a small portion of the television image 11. In the concrete embodiment example, there is a color marking 20 represented in the form of a square of a selected color located in the top right-hand corner of the television image.

### DETAILED DESCRIPTION OF THE INVENTION

In order to distinguish between multiple identifiers, the identifying equipment 50 has a predefined set of identifiers. In the present embodiment example, these are color markings 20 in the colors green, amber and red. The viewer of the television image 11 can memorize said color markings 20 and distinguish them one from the other very well. Confusion is highly unlikely with such a small cardinality of the set of identifiers.

The viewer of the television image 11, that is to say the television viewer, can now commence interacting with the system according to the invention and the apparatus according to the invention in order to purchase a specific article that is being advertised using the audio/video signal that has been marked with an identifier. In the present embodiment, the article concerned is an audio CD. The audio/video signal 1 that has not been marked with an identifier is a music video for one of the tracks on the audio CD.

If a television viewer should now decide that he would like to own the music track to the music video currently being shown, he begins to interact with the apparatus according to the invention. For example, he could use a mobile phone 82 to contact a receiver unit 84 of the communications equipment 60. If, then, for instance the music video, the audio CD for which the television viewer would like to purchase, was marked or identified with a color marking 20 which shows a green square in the television image 11, the television viewer then composes an SMS text containing the word “Green” and sends this via the receiver unit 64 to the communications equipment 60.

The communications equipment 60 can identify the television viewer, who had already previously registered with the communications equipment 60 at an earlier time, using his calling telephone number. This identification is achieved by means of the database of users 66. The communications equipment 60 assigns a code to the identifier input received, that is to say the term “Green”. The communications equipment can establish, using the identification database 52 which audio/video signal 1 was given the corresponding identifier. Since only the identifiers Red, Green or Amber are available in the present embodiment, there will be a plurality of audio/video signals 1 that have been given the same identifier by the identifying equipment 50. The communications equipment 60 uses the program database 92 to determine the audio/video signal 1 that was most recently published by the publication equipment 90 and carried the designated identifier. The communications equipment 60 uses the article database 42 to determine the article corresponding to the audio/video signal 1 already determined. Ultimately, therefore, the communications equipment 60 can use the SMS text received and the time of receipt of the SMS text to determine which article the television viewer probably wanted to order. As soon as the communications equipment 60 has determined which article this is, it sends, also by SMS text, an offer to the mobile phone 82 and thus to the television viewer, in which the price and nature of the article is precisely identified. The television viewer can now accept the offer by means of a further SMS text. The communications equipment 60 then prepares an order and saves this in an ordering database 62 connected to the communications equipment 60.

In the embodiment example, the communications equipment 60 is connected with production equipment 70. This production unit 70 comprises a CD burner 72 and a packing machine 74. A CD is created by the CD burner 72 and packed by the packaging machine 74 in accordance with the order from the ordering database 62. In a further process, the CD can be labeled with the television viewer's address data and sent to him.

In the embodiment described, all production steps are implemented automatically by the production unit 70. For other applications, i.e. for other articles, it may be preferable to carry out some or all of the production steps manually. In this case, the communications equipment 60 only prepares the order.

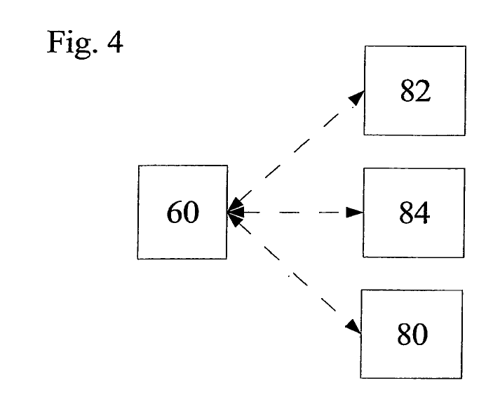

In the present embodiment example the television viewer interacts with the communications equipment 60 by means of a mobile telephone 82. In a further embodiment example, the receiver unit 64 can be designed such that it communicates with a simple telephone 80 (see FIG. 4), a PC 64 or any other suitable apparatus. Thus the identifier can be entered through a PC 64, for instance, which sends an e-mail to the communications equipment 60 or is in direct communication with the communications equipment 60 over the Internet.

In a further embodiment example, the television viewer is able to mark a plurality of articles by means of the method described. This means that the system receives a plurality of inputs from the television viewer within a defined transmission period and for each identifies an article, e.g. a music track, corresponding with the identifier input concerned. Each of these articles is marked for ordering. At a later time, the television viewer can process the list of marked articles created in this way and finally submit it, for example, via the Internet. In the embodiment described, therefore, this would mean a list of music tracks, which can be subsequently revised and is copied to an audio CD by the CD burner 72 when the order is finally submitted. It would also be conceivable to allow the television viewer to continue ordering until the volume of a medium, e.g. a CD or DVD, is exhausted, and then to finalize the ordering process.

Although the apparatus described thus far and the method described to this point is designed for ordering articles, e.g. pieces of music, it is easy for the person skilled in the art to see how the apparatus and the method can be modified in order to carry out polls or surveys with this apparatus and method. The communications equipment 60 then does not determine an article to be ordered, but determines an article, a product, a person or a service, to which a further vote is to be allocated by the identifier input. In the event of the interaction of a plurality of television viewers, the ten favorites of a plurality of persons can therefore be selected, for instance.

The apparatus described and the method described is also suitable for making an interactive game available to the television viewer or receiver. The television viewer could answer quiz questions by means of the identifier input, for instance. The television viewer giving the most correct answers being the winner and receiving a prize.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. Apparatus for ordering at least one article from a plurality of articles, comprising
a signal server (40) for providing a plurality of audio/video signals;
an article database (42) for storing relations between the plurality of articles and the plurality of audio/video signals;
identifying equipment (50) designed such that it assigns an identifier from a defined set of identifiers to each audio/video signal and stores this assignment in an identification database (52);
publication equipment (90) designed such that it publishes the audio/video signal together with its assigned identifier and saves the publication period in a program database (92); and
communications equipment (60) designed such that it receives from a recipient of the audio/video signal, more particularly from a television viewer, an identifier input and determines at least one article for ordering on the basis of the identifier input and the time of entry using data from the article database (42), the identification database (52) and the program database (92).

2. Apparatus in accordance with claim 1 characterized in that the cardinality of the set of identifiers is ≦10.

3. Apparatus in accordance with claim 1, characterized in that the identifier comprises signals that appear on reproduction of the published audio/video signal as color markings (20) visible to the recipient, more particularly in a traffic signal-like arrangement.

4. Apparatus in accordance with claim 3, characterized in that the color markings (20) essentially comprise the colors red, amber and green.

5. Apparatus in accordance with claim 1 characterized in that the identifier input comprises a text input, more particularly the input of a color name.

6. Apparatus in accordance with claim 1, characterized in that the communications equipment (60) comprises an SMS text receiver unit that receives an identifier input in the form of an SMS text.

7. Apparatus in accordance with claim 1, characterized in that the communications equipment (60) comprises telecommunications equipment for the reception of the identifier input.

8. Apparatus in accordance with claim 1, characterized in that the communications equipment (60) comprises a database of users (66).

9. Apparatus in accordance with claim 1, characterized in that the plurality of articles comprises a plurality of audio signals or audio/video signals or of data media with at least one audio signal or audio/video signal.

10. Apparatus in accordance with claim 1, characterized in that the publication equipment (90) comprises a transmitter unit for television programs.

11. Apparatus in accordance with claim 1, characterized in that the plurality of audio/video signals comprises music videos.

12. Method for ordering at least one article from a plurality of articles, comprising the steps of:
marking an audio/video signal assigned to the article with an identifier from a defined set of identifiers;
publishing the marked audio/video signal in a publication period;
receiving an identifier input at a reception time;
determining a set of articles, the assigned audio/video signals for which have been identified with an identifier that corresponds to the identifier input; and
selecting at least that article from the set of articles for which the interval between the reception time and a start time of the publication period of the assigned audio/video signal is the shortest.

13. Method in accordance with claim 12, characterized by the installation of an application, more particularly on a mobile phone for sending the identifier input, wherein the application offers a selection from the defined set of identifiers.

14. Method in accordance with claim 12 characterized in that the identifier input comprises a text input, more particularly an SMS text.

15. Method in accordance with claim 12, characterized by the dispatch of an offer, more particularly after the step for the selection of the article, comprising a description and/or a price for the at least one article.

16. Method in accordance with claim 12, characterized in that the cardinality of the set of identifiers is ≦10.

17. Method in accordance with claim 12, characterized in that the marking of an audio/video signal comprises mixing in a video signal with a color marker.

18. Method in accordance with claim 17, characterized in that the color marking comprises essentially the colors red or amber or green.

19. Method in accordance with claim 12, characterized by the step of registering a user, wherein the reception of the identifier input, comprises an identification of a registered user.

20. Method in accordance with claim 12, characterized in that publication comprises the broadcasting of a television signal to at least one television receiver (10).

21. Method in accordance with claim 12, characterized in that the plurality of articles comprises a plurality of audio signals or audio/video signals or of data media with at least an audio signal or audio/video signal.

22. Method in accordance with claim 12, characterized in that the audio/video signal comprises a music video.
